(19) United States
(12) Patent Application Publication
(10) Pub. No.: US 2020/0019675 A1
(43) Pub. Date: Jan. 16, 2020

(54) POLYGENIC RECOMMENDATIONS BASED ON INDIVIDUALIZED EXPRESSION OF GENETIC VARIANTS

(71) Applicant: Helix OpCo, LLC, San Carlos, CA (US)

(72) Inventors: Rani K. Powers, Broomfield, CO (US); Ryan P. Trunck, Denver, CO (US); Christopher M. Glode, Denver, CO (US)

(21) Appl. No.: 16/034,231

(22) Filed: Jul. 12, 2018

(51) Int. Cl. G06F 19/18; G06F 19/24; G06Q 30/06

(52) U.S. Cl. CPC G06F 19/18; G06Q 30/0631; G06F 19/24

(57) ABSTRACT

Systems and methods are provided for polygenic recommendations. One embodiment is a system that includes a polygenic server. The polygenic server includes an interface that acquires an indication of known genetic variants of an individual at predetermined genetic loci, and a controller that identifies a product for the individual, selects genetic variants from the known genetic variants based on the product, assigns a value to each selected genetic variant based on an aggregation directive for the product, calculates a polygenic score for the product based on the value of each selected genetic variant, and determines whether to recommend the product for the individual based on the polygenic score.

### FIELD

The disclosure relates to the field of genomics, and in particular, to consideration of the genotypes of individuals.

### BACKGROUND

It is not uncommon for phenotypic traits (i.e., observable traits such as eye color, hair color, etc.) to have an impact on the behavior or preferences of an individual. For example, individuals who have large spleens may engage in diving more often and with more aptitude than others, individuals who have thin eyelashes may utilize certain types of makeup more often than others, and individuals who have poor vision may utilize reading glasses more often than others. Even people who do not normally engage in certain activities may be genetically predisposed to benefit from (or have an aptitude for) those activities.

In many cases, such as in the example above related to spleen size, one or more phenotypic traits of an individual are not easily observable. This means that an individual may not even be aware of her phenotypic traits, or the significance thereof. This is unfortunate because such a person may never learn how to improve her life by leveraging knowledge of her phenotypic traits.

Hence, those who seek to identify their phenotypic traits, and how to benefit from or otherwise adapt their lives based on such phenotypic traits, seek out enhanced systems and methods for achieving these goals.

### SUMMARY

Embodiments described herein provide systems and techniques that engage in polygenic analysis of the genetic variants of an individual when determining whether to recommend a product to the individual. Genotype often directly influences or dictates the phenotypic traits of an individual. Because of this, embodiments described herein may analyze the genotype of an individual to seek out genetic variants that are associated with specific phenotypic traits. If genetic variants are present in the individual that are associated with a phenotypic trait, embodiments described herein may recommend products which are potentially relevant in light of the phenotypic trait. In short, embodiments described herein may consider the existence (or nonexistence) of specific alleles for a variety of different genes in combination when determining whether a product (e.g., a consumer item, a screening kit, a services package, an article or subscription, etc.) shall be recommended to an individual.

The systems and methods described herein provide a benefit because the genotype of an individual may indicate the existence of phenotypic traits that are not easily observable. The systems and methods described herein provide a further benefit because analysis of the genotype of an individual may lead to the discovery of numerous phenotypic traits for the individual (e.g., tens of thousands of phenotypic traits). This rich tapestry of context allows for product recommendations to the individual to be carefully tailored, and helps to prevent recommendations for non-relevant products that the individual may find undesirable.

One embodiment is a system that includes a polygenic server. The polygenic server includes an interface that acquires an indication of known genetic variants of an individual at predetermined genetic loci, and a controller that identifies a product for the individual, selects genetic variants from the known genetic variants based on the product, assigns a value to each selected genetic variant based on an aggregation directive for the product, calculates a polygenic score for the product based on the value of each selected genetic variant, and determines whether to recommend the product for the individual based on the polygenic score.

A further embodiment is a method. The method includes acquiring an indication of known genetic variants of an individual at predetermined genetic loci, identifying a product for the individual, selecting genetic variants from the known genetic variants based on the product, assigning a value to each selected genetic variant based on an aggregation directive for the product, calculating a polygenic score for the product based on the value of each selected genetic variant, and determining whether to recommend the product for the individual based on the polygenic score.

Yet another embodiment is a non-transitory computer readable medium embodying programmed instructions which, when executed by a processor, are operable for performing a method. The method includes acquiring an indication of known genetic variants of an individual at predetermined genetic loci, identifying a product for the individual, selecting genetic variants from the known genetic variants based on the product, assigning a value to each selected genetic variant based on an aggregation directive for the product, calculating a polygenic score for the product based on the value of each selected genetic variant, and determining whether to recommend the product for the individual based on the polygenic score.

Other illustrative embodiments (e.g., methods and computer-readable media relating to the foregoing embodiments) may be described below. The features, functions, and advantages that have been discussed can be achieved independently in various embodiments or may be combined in yet other embodiments further details of which can be seen with reference to the following description and drawings.

### DESCRIPTION OF THE DRAWINGS

Some embodiments of the present disclosure are now described, by way of example only, and with reference to the accompanying drawings. The same reference number represents the same element or the same type of element on all drawings.

FIG. 1 is a block diagram of a polygenic evaluation system in an illustrative embodiment.

FIG. 2 is a flowchart illustrating a method for operating a polygenic evaluation system in an illustrative embodiment.

FIG. 3 is a diagram illustrating a product library describing a variety of candidate products in an illustrative embodiment.

FIG. 4 is a diagram illustrating aggregation directives which indicate values of genetic variants with respect to specific products in an illustrative embodiment.

FIG. 5 is a diagram illustrating rankings of candidate products with respect to each other in an illustrative embodiment.

FIG. 6 is a flowchart illustrating a method for escalating a rank of a product, based on the existence of a decisive genetic variant in an illustrative embodiment.

FIG. 7 is a flowchart illustrating a method for determining whether to include products in a recommendation list in an illustrative embodiment.

FIG. 8 is a diagram illustrating a recommendation list in an illustrative embodiment.

FIG. 9 is a diagram illustrating a Variant Call Format (VCF) file that has been modified to include product-related information in an illustrative embodiment.

FIG. 10 is a diagram illustrating a Browser Extensible Data (BED) file that has been modified to include product-related information in an illustrative embodiment.

FIG. 11 depicts an illustrative computing system operable to execute programmed instructions embodied on a computer readable medium.

### DESCRIPTION

The figures and the following description depict specific illustrative embodiments of the disclosure. It will thus be appreciated that those skilled in the art will be able to devise various arrangements that, although not explicitly described or shown herein, embody the principles of the disclosure and are included within the scope of the disclosure. Furthermore, any examples described herein are intended to aid in understanding the principles of the disclosure, and are to be construed as being without limitation to such specifically recited examples and conditions. As a result, the disclosure is not limited to the specific embodiments or examples described below, but by the claims and their equivalents.

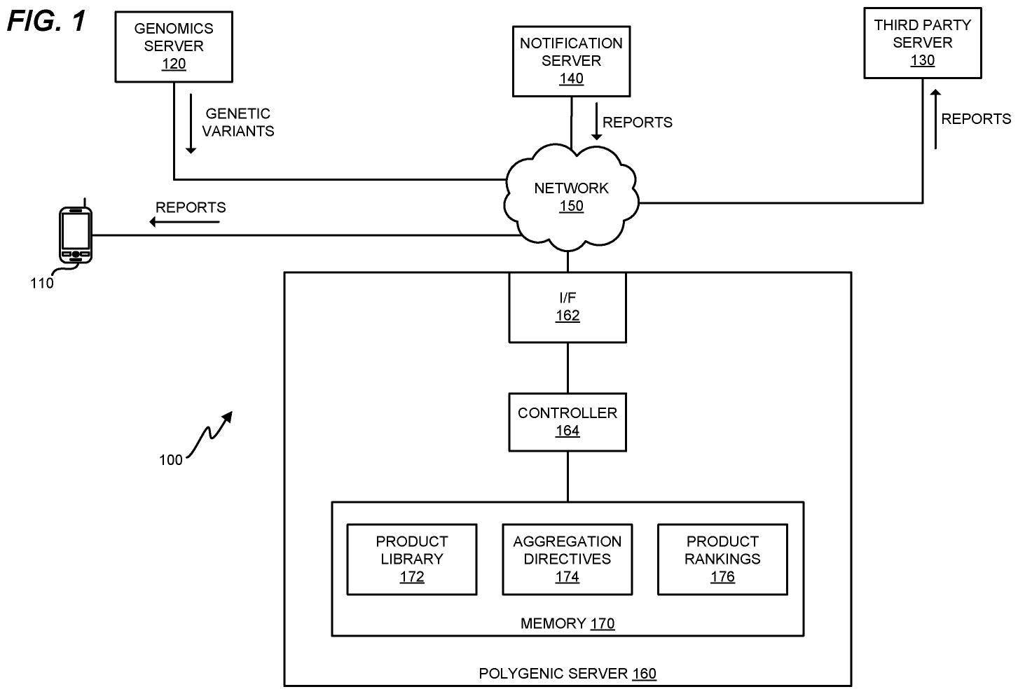

FIG. 1 is a block diagram of a polygenic evaluation system 100 in an illustrative embodiment. Polygenic evaluation system 100 comprises any system, device, or component that selectively recommends products to an individual based on genetic variants of the individual (i.e., genetic variants that are included within the genetic makeup of the individual). Specifically, polygenic evaluation system 100 generates a polygenic score for each product based on multiple genetic variants of an individual, and decides whether or not to recommend products to the individual based on these polygenic scores.

In this embodiment, polygenic evaluation system 100 includes user device 110 (e.g., a computer, cellular phone, or tablet of a user), genomics server 120, and one or more third party servers 130. These entities provide input via network 150 (e.g., the Internet, a combination of small networks, etc.) to polygenic server 160. Specifically, user device 110 may provide login information, commands, authorizations, and user feedback, while genomics server 120 may provide records (e.g., Variant Call Format (VCF) files, Browser Extensible Data (BED) files, other sequencing or genotyping formats) indicating genetic variants of an individual. As used herein, the term “genetic variant” refers to a variation of an individual gene (e.g., alleles, Single Nucleotide Polymorphisms (SNPs), etc.), epigenetic variations, variations in nucleotides that regulate gene expression or gene activity, etc.

Records maintained at genomics server 120 may indicate the genomics of an entire population (e.g., millions of individuals) on an individual-by-individual basis. In such an embodiment, each record may indicate genetic variants found within a specific individual, and different records may correspond with different individuals. In a further embodiment, a record at genomics server 120 may indicate the existence (or non-existence) of a specific genetic variant for a large number of specified individuals. Depending on the individual that is being considered by polygenic server 160, genomics server 120 may select, aggregate, and/or compile suitable records for transmission to polygenic server 160.

Third party server 130 may report the characteristics of an individual to polygenic server 160 for consideration. As used herein, the “characteristics” of an individual include phenotypes of an individual (e.g., hair color, eye color, height, etc.), demographics of the individual (e.g., ancestry, age, sex), behaviors of the individual (e.g., fitness patterns, dietary habits, travel patterns), a “digital footprint” of the individual (e.g., interactions on a social network or genealogy website, financial transactions), preferences of the individual (e.g. “Likes” of a sports team or political party), a history of medical treatment for the individual, etc.

With the above description provided of “characteristics,” it will be understood that characteristics may be reported by third party server 130 in the form of records that indicate characteristics of specific individuals. For example, the characteristics data may describe Electronic Health Records (EHRs), a pulse rate of an individual over time during a workout, a level of cardiovascular health, etc. In other examples, the records may indicate a pattern of purchases by an individual that suggest a specific characteristic, such as nearsightedness, acid reflux, or a desire for travel.

Polygenic server 160 may use information provided by the various entities described above when determining whether to recommend products to individuals. For example, polygenic server 160 may analyze received login information to determine whether the user has permission to access records for a specific individual, or may use profile information for the individual to determine whether the user has permission to receive recommendations for certain categories of products for the individual.

In this embodiment, polygenic server 160 includes controller 164. Controller 164 manages the operations of polygenic server 160 and controls the process of determining which products are relevant to an individual based on the genetic variants of that individual. Controller 164 may be implemented, for example, as custom circuitry, as a hardware processor executing programmed instructions, or some combination thereof.

Polygenic server 160 also includes interface (I/F) 162. I/F 162 receives and transmits data via network 150, and may comprise any suitable component for transmitting data, such as an Ethernet port, a wireless transceiver compatible with IEEE 802.11 protocols, etc.

Controller 164 stores records received via I/F 162 in memory 170. Memory 170 also stores product library 172, aggregation directives 174, and product rankings 176. These components facilitate processes performed by controller 164. Specifically, product library 172 provides a list of products that may be considered for recommendation to an individual, aggregation directives 174 indicate how different genetic variants of an individual will processed, and product rankings 176 indicate the order of importance of recommendations for different products. Memory 170 comprises any suitable non-transitory computer readable storage medium, such as a solid-state memory, hard disk, etc.

Notification server 140 generates reports and/or recommendations based on input from polygenic server 160. Notification server 140 may transmit reports to user device 110, third party server 130, and/or any other suitable entities.

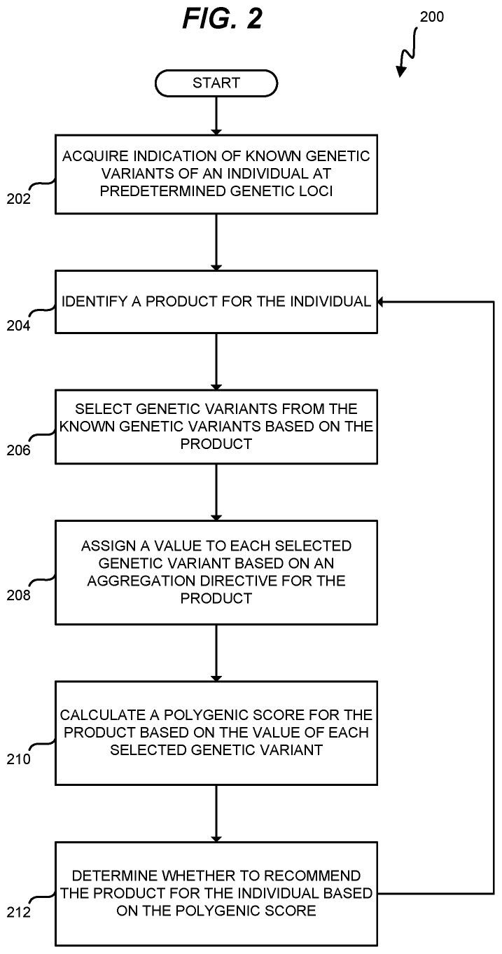

Illustrative details of the operation of polygenic evaluation system 100 will be discussed with regard to FIG. 2. Assume, for this embodiment, that a user (e.g., a medical practitioner, a family member, a third party such as a social network or gym, etc.) has accessed polygenic evaluation system 100 and wishes to determine which products are most relevant for an individual. To this end, the user operates user device 110 to submit a request for product recommendations. The request includes an identifier for the individual. In one embodiment, the request identifies multiple individuals, and the steps of method 200 are performed for each individual.

FIG. 2 is a flowchart illustrating a method 200 for operating a polygenic evaluation system in an illustrative embodiment. The steps of method 200 are described with reference to polygenic evaluation system 100 of FIG. 1, but those skilled in the art will appreciate that method 200 may be performed in other systems. The steps of the flowcharts described herein are not all inclusive and may include other steps not shown. The steps described herein may also be performed in an alternative order.

According to method 200, I/F 162 of polygenic server 160 receives the request from user device 110 and determines that the user is authorized to make the request for the individual. In response to determining that the user is authorized, controller 164 directs I/F 162 to transmit a request to genomics server 120 for records describing the individual.

In step 202, controller 164 acquires an indication (e.g., one or more records) of known genetic variants of the individual at predetermined genetic loci (e.g., locations on a chromosome, locations within the genome as a whole, a range of locations on a chromosome, etc.). The indication may comprise a list of known genetic variants for the individual, along with the genetic loci occupied by those genetic variants. The indication may be received from genomics server 120 or may already be stored in memory 170, and may comprise a VCF file provided by genomics server 120, a BED file stored in memory 170, etc.

Controller 164 also acquires information describing products that are being considered for recommendation. For example, in one embodiment controller 164 reviews an entire product library 172 of candidate products. In further embodiments, controller 164 reviews products in specific categories, products specifically indicated by the individual or the user, or even products that are associated with behaviors of the individual (e.g., products in categories that have been “liked” by the individual on a social network).

Controller 164 proceeds to step 204 and identifies a product for the individual (step 204). For example, controller may select one of the products described above. Controller 164 will calculate a polygenic score for the product indicating how relevant the product is to the individual, based on the genetic makeup of the individual. If the polygenic score exceeds a threshold amount, the product may be recommended for the individual.

With the product identified, controller 164 selects genetic variants from the known genetic variants of the individual, based on the product (step 206). This step involves determining which genetic variants are relevant to the product and are also are found within the individual. For example, aggregation directives 174 may indicate that for a given product, the existence or nonexistence of specified SNPs at ten thousand predetermined genetic loci are relevant to the product. If the individual has any of these specified SNPs, those SNPs may be selected. The genetic variants (and their corresponding genetic loci) may vary depending on the product that has been identified in step 204. For example, a product related to diving equipment may consider substantially different genetic variants at substantially different genetic loci than a product related to reading glasses.

Controller 164 assigns a value to each selected genetic variant based on an aggregation directive for the product (step 208). For example, the aggregation directive may indicate a value to assign to each genetic variant, if such a genetic variant is found within the individual.

Controller 164 proceeds to calculate a polygenic score for the product based on the value of each selected genetic variant (step 210). The process of calculating a polygenic score may be indicated in aggregation directives 174. In one embodiment, the values assigned to each selected genetic variant are summed. In further embodiments, values assigned to selected genetic variants may be multiplied, divided, added, subtracted, or subjected to any suitable combination of mathematical operations in any suitable order. For example, the existence of a first genetic variant might only be relevant if it exists in combination with a second genetic variant. In such a case, the value of the first genetic variant may be multiplied with the value assigned to the second genetic variant, or the value of the first genetic variant may be ignored if the second genetic variant has not been detected.

In step 212, controller 164 determines whether to recommend the product to the individual based on the polygenic score. For example, controller 164 may identify a threshold amount, and recommend the product if the polygenic score of the product is above the threshold amount. The threshold amount may vary between products, or may be defined such that it remains constant across all products. In further embodiments, controller 164 may combine the polygenic score with scores resulting from other sources of data. For example, a characteristics score may be generated based on characteristic information (e.g., phenotype information) provided by a user and may be combined with the polygenic score. The combined score may then be compared to the threshold amount. Controller 164 may even consider information such as lists of preferred products and undesired products when determining whether or not a recommendation should be provided.

Controller 164 proceeds to a next candidate product for the individual, and may repeat steps 204-212 for as many candidate products as desired. After determining that one or more products shall be recommended for the individual, controller 164 may generate and transmit information identifying these products to notification server 140 for provisioning to the user. Notification server 140 receives this information from polygenic server 160 via network 150, and generates and transmits reports to genomics server 120, third party server 130, and/or one or more user devices 110. The specific entities that receive the reports, and the content of these reports, may vary depending on permissions set by the user or the individual. The reports may list recommendations for the products and may be accompanied by descriptive or contextual information relating to the products.

In one embodiment, recommendations for different products are provided to different entities. For example, a recommendation for follow-up sequencing or genotyping may be provided to both user device 110 and genomics server 120, while a recommendation for gym membership, diving equipment, or reading glasses may be provided to one or more third party servers 130 and/or user device 110. These recommendations may be used by third parties to provide content to the user or to the individual.

Recommendations may also include contextual language indicating why a product is being recommended. For example, controller 164 may determine a known phenotype associated with the genes of the individual and may report these phenotypes as a basis for making the recommendation. A recommendation may therefore state that “based on genomics, it appears that the individual has a low foot arch and is overweight. Thus, we recommend a hiking orthopedic support that caters to these aspects of body type.” Explaining the reasoning behind a product recommendation may help the user to rapidly determine whether the recommendation is relevant or not.

Notification server 140 may further anonymize personal data for the individual within reports if desired, in order to ensure that privacy is maintained. For example, if a report is provided to a third party, data describing the individual may be anonymized to protect the privacy of the individual. The anonymization may be performed by omitting personally identifiable information for the user, providing a masked email address that forwards to the individual (instead of the personal email address of the individual), etc.

Method 200 provides a substantial advantage over prior techniques because it enables the genotype of an individual to be used in order to identify and recommend products that are highly relevant to the individual. This in turn allows an individual to gain insights into her body, potential preferences, and potential aptitudes. Hence, the techniques described therein may help an individual to live her life to the fullest potential.

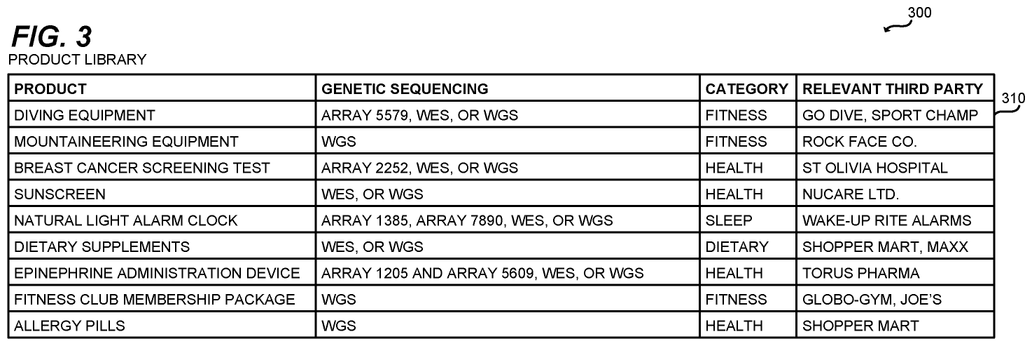

FIGS. 3-5 illustrate various features of illustrative product libraries, aggregation directives, and product rankings that may be used by controller 164 during method 200. Specifically, FIG. 3 is a diagram illustrating a product library 300 describing a variety of candidate products in an illustrative embodiment. In this embodiment, each product that may be considered for recommendation is listed in an entry 310.

Each entry indicates a name for the product, as well as a preferred amount or type of genetic sequencing or genotyping considered with regard to product recommendations. Different types of genetic sequencing or genotyping performed for an individual may lead to different genetic variants of the individual being known. For example, an individual's genetic variants may have been recorded in the form of whole exome data (e.g., Whole Exome Sequencing (WES)), whole genome data (e.g., Whole Genome Sequencing (WGS)), one or more Deoxyribonucleic Acid (DNA) microarrays, etc. For a DNA microarray, a small portion of the individual's exome (e.g., comprising only a few hundred thousand Single Nucleotide Polymorphisms (SNPs)) has been genotyped and listed. Because different types of sequencing and/or genotyping provide information on different genetic variants, different types of genetic sequencing and/or genotyping may be desired in order to determine whether certain products should be recommended.

In further embodiments, the genetic sequencing or genotyping portion of an entry is replaced by a listing. The listing reports each genetic variant (and corresponding genetic locus) that is considered when calculating a polygenic score for the product named in the entry.

Each entry 310 in product library 300 also indicates a category of the product, as well as third parties that may be interested in providing the product to the individual. These third parties may provide offers to the individual based on the recommendation. For example, if diving equipment is recommended for an individual, a sporting good store may submit offers to the individual (or user) that are related specifically to diving equipment.

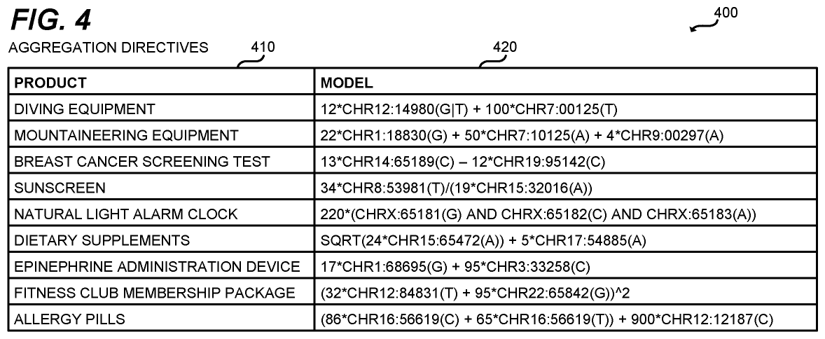

FIG. 4 is a diagram illustrating aggregation directives 400 which indicate values of genetic variants with respect to specific products in an illustrative embodiment. According to FIG. 4, each entry in aggregation directives 400 indicates a name or identifier for the product in column 410, and further indicates a scoring model in column 420 for evaluating the product. The scoring model provides values for genetic variants at predefined genetic loci, and indicates how assigned values may be mathematically combined in order to calculate a polygenic score.

Specifically, each scoring model indicates one or more genetic loci, one or more nucleobases expected at the genetic loci, and values to provide if an expected nucleobase is present at a genetic loci. For example, an entry that states “100*CHR7:00125(T)” may assign a value of one hundred if the nucleobase at chromosome 7, position 125 is thymine. In a similar fashion, an entry that states “12*CHR12:14980(G|T)” may assign a value of twelve if the nucleobase at chromosome 12, position 14980 is either guanine or thymine. Various assigned values may be mathematically combined as desired, and a scoring model may even assign values to entire sequences of nucleobases. For example, an entry that states “220*(CHRX:65181(G) AND CHRX:65182(C))” may assign a value of two hundred and twenty only if the nucleobase at the X chromosome, position 65181 is guanine, and the nucleobase at the X chromosome, position 65182 is cytosine. Alternatively, a dash may be used instead of a logical operator to indicate a sequence of nucleobases. Thus, “220*(CHRX:65181-65183(GCT))” may assign a value of two hundred and twenty only if the nucleobase at the X chromosome, position 65181 is guanine, and the nucleobase at the X chromosome, position 65182 is cytosine, and the nucleobase at the X chromosome, position 65183 is thymine.

In one embodiment, values assigned to genetic variants are based on estimates of the variant's “effect size” from a population study. In a further embodiment, values assigned to genetic variants are based on allele frequency. For example, genetic variants that are particularly rare may be assigned higher values. In a further embodiment, values may be altered (e.g., scaled, increased in value, or decreased in value) based on a genotype quality (e.g., SNP quality scores, Phred scores, etc.) assigned to each known genetic variant. Genotype quality scores do not indicate an overall health or value of a genetic variant with respect to other variants, but rather indicate a level of confidence that an individual actually has a reported genetic variant.

While only a few genetic variants are listed for each entry depicted in FIG. 4, it is not uncommon for an entry to consider tens of thousands or even millions of genetic variants at tens of thousands or even millions of genetic loci.

In some embodiments, controller 164 generates a recommendation if the polygenic score for a product is above a threshold amount. In embodiments where the threshold amount of polygenic score for a recommendation varies across different products, each entry in aggregation directives 400 may report a different threshold amount for its product. In embodiments where the threshold amount is uniform across all products, the scoring models in each entry may be calibrated to provide a polygenic score within a normalized range (e.g., between zero and one, between one and hundred, etc.).

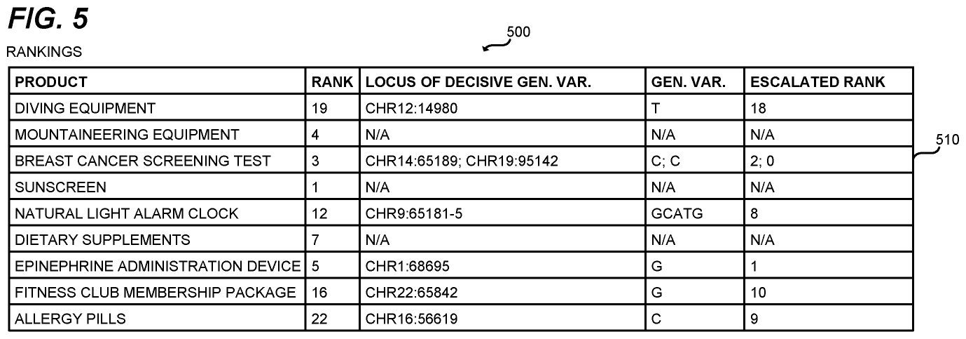

FIG. 5 is a diagram illustrating rankings 500 of candidate products with respect to each other in an illustrative embodiment. Rankings 500 may be utilized when multiple product recommendations exist in order to sort those recommendations. For example, rankings may indicate an order in which to provide recommendations for products. In FIG. 5, each entry 510 lists a product name and a corresponding rank. Each entry 510 also may indicate the locus of a decisive genetic variant. As used herein, a “decisive” genetic variant is a genetic variant whose existence alters (e.g., escalates or de-escalates) the rank of a product with respect to other products. For example, a decisive genetic variant may indicate an astounding aptitude for diving, and hence escalate the rank of a recommendation for diving equipment. Multiple decisive variants may be listed for each product, and these decisive variants may have different escalated ranks. In one embodiment, no genetic variants are listed as decisive, but a polygenic score above an escalation amount may result in an escalated ranking of the product.

Ranking products is particularly valuable in circumstances where there are limited opportunities to make recommendations to the user. For example, if a social network allows for only a few recommendations to be provided to the user, it becomes important for the most relevant or notable products (as indicated by rank) to be recommended.

Third parties may also consider whether a product has been escalated or not when generating offers for the individual. This may be particularly important when a product can be offered to an individual via multiple channels of trade, at multiple levels of emphasis, and/or at multiple price points. For example, a third party may provide an offer via a first channel (e.g., an internet advertisement or email) for a product that is not escalated, but may provide the offer via a second channel (e.g., direct mailing or a phone call) for a product that has been escalated. In a similar manner, the content and/or price of an offer may vary depending on whether the rank of a product has been escalated.

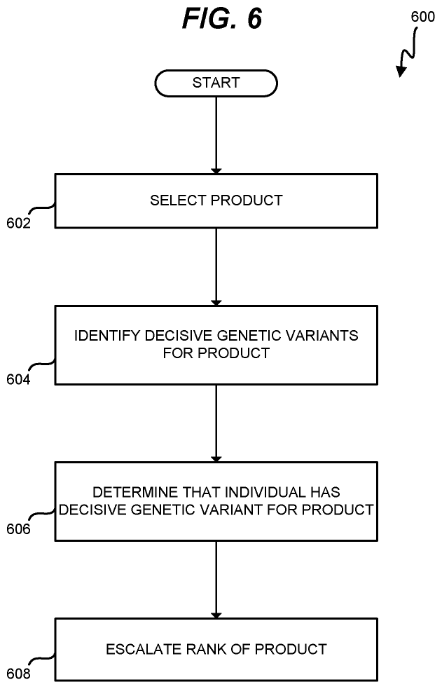

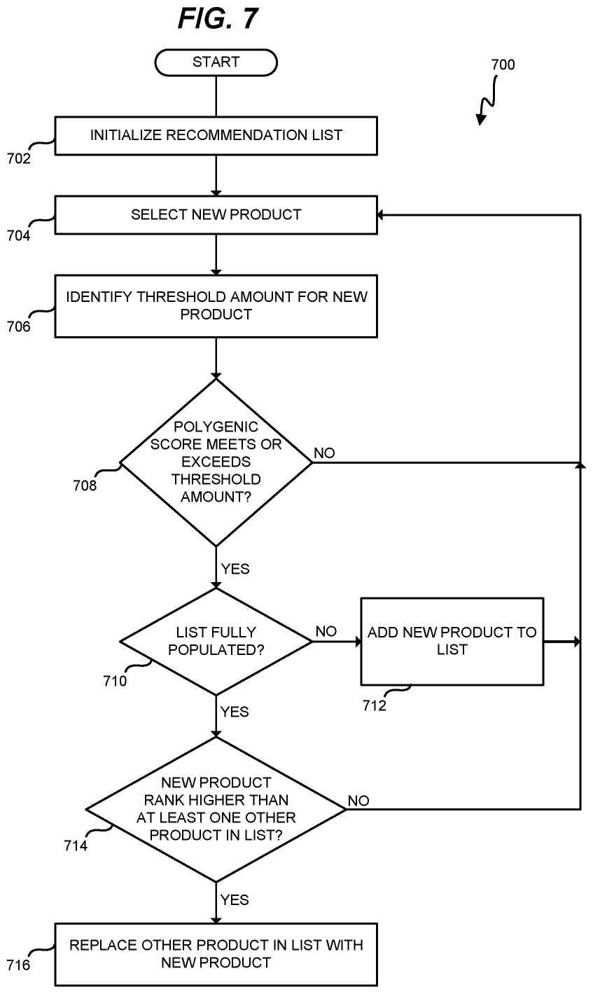

Having described illustrative implementations of product libraries, aggregation directives, and product rankings, the following FIGS. 6-7 discuss methods for arranging product recommendations based on rank.

FIG. 6 is a flowchart illustrating a method 600 for escalating a rank of a product, based on the existence of a decisive genetic variant in an illustrative embodiment. Method 600 may be performed for example after step 212 of method 200, such as after it has been determined that multiple product recommendations exist. Method 600 facilitates the process of determining which product recommendations are of the highest priority.

According to method 600, in step 602 controller 164 selects a product. For example controller 164 may select a product having a polygenic score that meets or exceeds a threshold amount. Controller 164 proceeds to identify decisive genetic variants for the product in step 604. This process includes accessing product rankings 176 to identify a genetic locus for each decisive genetic variant, as well as a nucleobase or sequence of nucleobases found in each decisive genetic variant.

Controller 164 determines that the individual has at least one decisive genetic variant (in step 606), by reviewing one or more genetic records for the individual. In response to determining that the individual has the decisive genetic variant, controller 164 escalates the rank of the product with respect to other products in step 608.

FIG. 7 is a flowchart illustrating a method 700 for determining whether to include products in a recommendation list in an illustrative embodiment. Method 700 may be performed for example as part of step 212 depicted in FIG. 2.

According to FIG. 7, in step 702 controller 164 initializes a recommendation list in memory 170. The list is limited to a predefined number of products, and may be initialized in an empty state wherein no products are listed.

Controller 164 proceeds to select a new product in step 704. This may comprise selecting a product for which a polygenic score has been calculated (e.g., as described in step 210 of FIG. 2). Controller 164 identifies a threshold amount for the product in step 706, and determines in step 708 whether the polygenic score for the new product meets or exceeds the threshold amount. If the polygenic score for the new product does not meet or exceed the threshold amount, then no recommendation for the product will be generated, and controller 164 proceeds to step 704 to select a new product.

Alternatively, if the polygenic score does meet or exceed the threshold amount, then a recommendation of the product for the individual is relevant. However, it is not yet known whether a recommendation for the new product is more important than recommendations for other products. In order to determine whether or not the new product is important enough to be recommended, controller 164 determines whether the recommendation list is already fully populated with products in step 710. If not, controller 164 adds the new product to the recommendation list in step 712.

Alternatively, if the recommendation list is already fully populated, then controller 164 determines whether the rank for the new product is higher than at least one other product in the recommendation list in step 714. As used herein, a “higher” rank indicates a rank of higher priority than another rank. Thus, depending on whether ranks are prioritized in ascending or descending order, a rank with a numerical value of one may be higher or lower than a rank with a numerical value of five.

If the new product has a higher rank than at least one other product in the list, controller 164 replaces the other product in the list with the new product in step 716. Alternatively, if the new product does not have a rank higher than at least one other product in the list, then controller 164 may proceed to step 704 and select another new product. By iterating through steps 704-716, controller 164 may ensure that the recommendation list is populated with products having the highest priority.

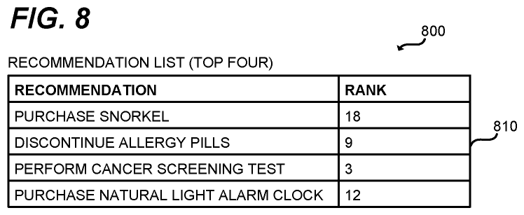

FIG. 8 is a diagram illustrating a recommendation list 800 in an illustrative embodiment. According to FIG. 8, recommendation list 800 includes entries 810 which each indicate a product for recommendation, and further indicate a rank for the product. Recommendation list 800 may be used, for example, as part of method 700 of FIG. 7 discussed above.

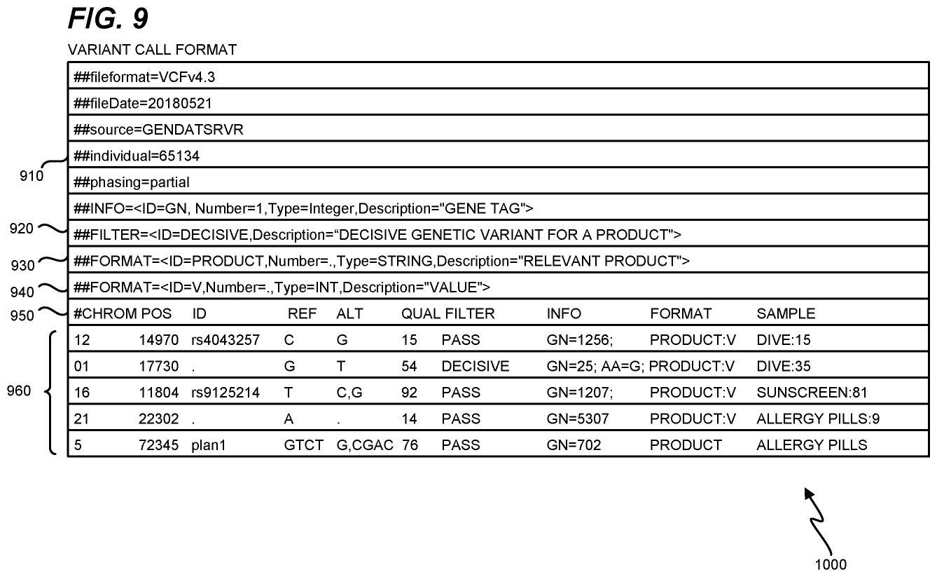

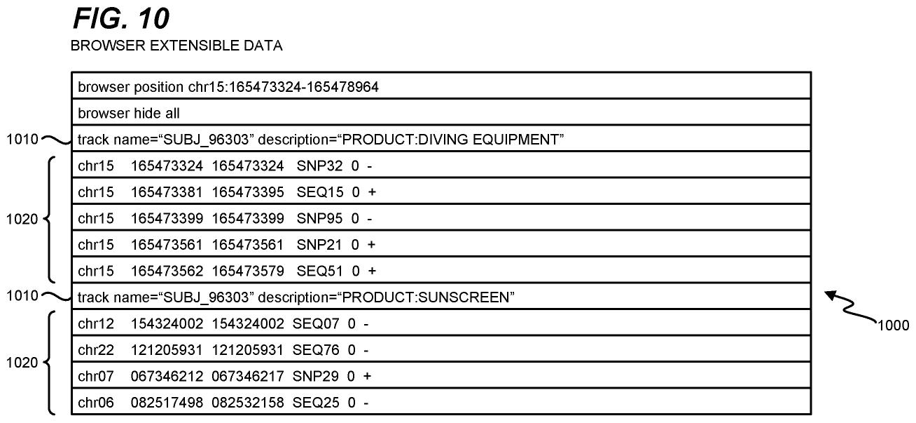

FIGS. 9-10 illustrate modifications to various genomic reporting formats in order to include product-related information in illustrative embodiments. For example, FIG. 9 depicts a VCF file 900 that indicates genetic variants that an individual has. The individual is identified by an ID number in a meta-information line 910. VCF file 900 also includes a filter line 920, a first format line 930, and a second format line 940. Filter line 920 defines a filter indicating whether or not a genetic variant is decisive for a product. Hence, if one of data lines 960 refers to a decisive genetic variant, this may be indicated by the use of “DECISIVE” in the filter field for that data line (e.g. as shown in the second data line).

The format lines define how product-related content may be included within each of the data lines 960. Specifically, first format line 930 indicates that each of data lines 960 may report any suitable number of products in string format, and second format line 940 indicates that each of data lines 960 may report any suitable number of values.

Each genetic variant is indicated in one or more of data lines 960. The content of each data line is formatted according to header line 950, which lists eight fixed columns of data expected by the VCF file format. These fixed columns are followed by a format column and a sample column. The format column indicates how additional content within a data line will be arranged, while the sample column provides the additional content organized according to the format column. For example, a format column that recites “PRODUCT:V”, when read in light of the format lines above, indicates that a the sample column will include a product name, followed by a colon and an integer value.

In this instance, a majority of the data lines each indicate a genetic variant, a product that is relevant for the genetic variant, and a value of that genetic variant with as it relates to the product. However, the bottom data line foregoes assignment of a value, and instead recites only the product that the genetic variant relates to. In further embodiments, a single data may recite and assign values for each of multiple products.

When VCF file 900 (or similar formats) are utilized, the polygenic scores for multiple products may be quickly ascertained, because values and products related to each genetic variant are listed in a manner that is centralized and easily accessible. This reduces processing burdens associated with analyzing the genetic variants of the individual, which is highly beneficial given the many gigabytes of data found within the human genome.

FIG. 10 is a diagram illustrating a Browser Extensible Data (BED) file 1000 that has been modified to include product-related information in an illustrative embodiment. BED file 1000 describes how genomic data in a binary BED file (not shown) is formatted when it is displayed. Hence, BED file 1000 does not include the genomic data itself, but rather describes how data in an accompanying binary BED file may be shared. BED file 1000, and the accompanying binary BED file, may be transmitted to authorized users via genomics server 120.

As shown in FIG. 10, BED file 1000 includes track lines 1010. Each track line 1010 includes a name and a description. The name is set to an anonymized identifier for an individual, and the description recites a product to consider for recommendation. The BED file follows each track line 1010 with one or more data lines 1020. The data lines 1020 following each track line each report a genetic variant (or genetic locus) that may contribute to a polygenic score for the product listed in the track line above it. In this manner, in order to determine relevant genetic variants for a product, controller 164 need not sift through large swaths of genomic data, but rather may identify a track line for the product, and review data lines following that track line. BED file 1000 may include tracks for one or multiple individuals relating to one or multiple products as desired.

### Examples

In the following examples, additional processes, systems, and methods are described in the context of a polygenic evaluation system.

In this embodiment, a user logs in to polygenic server 160 and requests a set of product recommendations in categories corresponding with the outdoors and fitness. Controller 164 reviews product library 172 and identifies a set of twelve candidate products in the listed categories. Controller 164 further determines that whole exome data, whole genome data, or a set of three different DNA microarrays are desired in order to determine whether or not to recommend these candidate products for an individual. This determination stems from the fact that the genetic loci which are considered relevant for the analysis are represented in the whole genome data, the whole exome data, and the combination of the three DNA microarrays.

Controller 164 proceeds to analyze predetermined genetic loci listed for each of the twelve candidate products, and assigns values to genetic variants at the genetic loci if their genetic variants match those listed in aggregation directives 174. Specifically, controller 164 identifies the existence of thirty three different genetic variants that are relevant for a first product comprising a set of hiking orthotic supports. Many of these genetic variants relate to skin sensitivity, arch size, and phenotypic traits that contribute to obesity. Controller 164 also identifies the existence of two hundred and fifty eight different genetic variants that are relevant for a second product comprising a diving snorkel mask. Many of these genetic variants relate to phenotypic traits that indicate lung capacity, spleen size, skin sensitivity to rubber or silicone, and forehead size.

For each product, controller 164 consults aggregation directives 174 in order to assign values to each of the genetic variants, and aggregates the values as indicated by aggregation directives 174 in order to calculate a polygenic score. Polygenic scores for the first product and the second product are above a threshold amount of one hundred, and thus controller 164 elects to recommend both the first product and the second product. Controller 164 also determines that the polygenic score for the second product is greater than an escalation amount of two hundred. Controller 164 therefore escalates a rank of a recommendation for the second product, and marks the recommendation as escalated. Controller 164 determines that the first product and the second product are the only products which are subject to recommendations. Controller 164 then arranges recommendations for the first product and the second product according to rank, and transmits the recommendations to notification server 140.

Notification server 140 generates a report describing the first product and the second product to the user. The report recites phenotypes of the individual defined by the individual's genetic variants, and further indicates how and why the first product and second product are attuned to the phenotype of the individual. Notification server 140 also retrieves information from third party server 130 that includes images, text, pricing, and contact information for vendors of the first product and the second product, and includes this information in the report. The report is sent to the user for review and consideration. Notification server 140 further reviews a profile for the user, and determines that the user has opted in for third party offers. Notification server 140 therefore proceeds to include the individual, as well as contact information for the individual, in an “interested parties” list for the first product and the second product. The interested parties list is regularly updated with new individuals, and is transmitted to vendors or suppliers of the first product and the second product on a periodic basis. The vendors may then directly contact the user in order to provide direct offers for the first product and/or second product.

Any of the various computing and/or control elements shown in the figures or described herein may be implemented as hardware, as a processor implementing software or firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

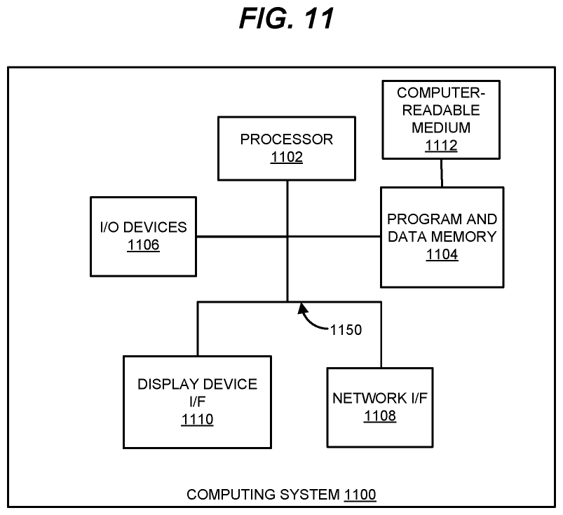

In one particular embodiment, instructions stored on a computer readable medium direct a computing system of user device 110, polygenic server 160 and/or notification server 140 to perform the various operations disclosed herein. FIG. 11 depicts an illustrative computing system 1100 operable to execute a computer readable medium embodying programmed instructions. Computing system 1100 is operable to perform the above operations by executing programmed instructions tangibly embodied on computer readable storage medium 1112. In this regard, embodiments may utilize instructions (e.g., code) accessible via computer-readable medium 1112 for use by computing system 1100 or any other instruction execution system. For the purposes of this description, computer readable medium 1112 comprises any physical media that is capable of storing a program for use by computing system 1100. For example, computer-readable medium 1112 may be an electronic, magnetic, optical, electromagnetic, infrared, semiconductor device, or other non-transitory medium. Examples of computer-readable medium 1112 include a solid state memory, a magnetic tape, a removable computer diskette, a random access memory (RAM), a read-only memory (ROM), a rigid magnetic disk, and an optical disk. Current examples of optical disks include Compact Disk-Read Only Memory (CD-ROM), Compact Disk-Read/Write (CD-R/W), Digital Video Disc (DVD), and Blu-Ray Disc.

Computing system 1100, which stores and/or executes the instructions, includes at least one processor 1102 coupled to program and data memory 1104 through a system bus 1150. Program and data memory 1104 include local memory employed during actual execution of the program code, bulk storage, and/or cache memories that provide temporary storage of at least some program code and/or data in order to reduce the number of times the code and/or data are retrieved from bulk storage (e.g., a spinning disk hard drive) during execution.

Input/output or I/O devices 1106 (including but not limited to keyboards, displays, touchscreens, microphones, pointing devices, etc.) may be coupled either directly or through intervening I/O controllers. Network adapter interfaces 1108 may also be integrated with the system to enable computing system 1100 to become coupled to other computing systems or storage devices through intervening private or public networks. Network adapter interfaces 1108 may be implemented as modems, cable modems, Small Computer System Interface (SCSI) devices, Fibre Channel devices, Ethernet cards, wireless adapters, etc. Display device interface 1110 may be integrated with the system to interface to one or more display devices, such as screens for presentation of data generated by processor 1102.

What is claimed is:

1. A system comprising:
a polygenic server comprising:
an interface that acquires an indication of known genetic variants of an individual at predetermined genetic loci; and
a controller that identifies a product for the individual, selects genetic variants from the known genetic variants based on the product, assigns a value to each selected genetic variant based on an aggregation directive for the product, calculates a polygenic score for the product based on the value of each selected genetic variant, and determines whether to recommend the product for the individual based on the polygenic score.

2. The system of claim 1 wherein:
the product is one of multiple candidate products, and for each of the multiple candidate products, the controller: selects genetic variants from the known genetic variants based on the candidate product, assigns a value to each selected genetic variant based on an aggregation directive for the candidate product, calculates a polygenic score for the candidate product based on the value of each selected genetic variant, and determines whether to recommend the candidate product for the individual based on the polygenic score.

3. The system of claim 2 wherein:
the controller disqualifies candidate products having a polygenic score below a threshold amount, and generates recommendations for candidate products having a polygenic score above the threshold amount.

4. The system of claim 2 wherein:
the controller determines an order of prioritization of the candidate products, based on ranks assigned to the candidate products.

5. The system of claim 4 wherein:
the controller alters a rank assigned to a candidate product in response to determining that the individual has a genetic variant that is categorized as decisive for that candidate product.

6. The system of claim 1 wherein:
the aggregation directive indicates a first value for a first genetic variant at a predetermined genetic locus, and indicates a second value for a second genetic variant at the predetermined genetic locus.

7. The system of claim 1 wherein:
values assigned to the selected genetic variants are based on allele frequency of the selected genetic variants.

8. A method comprising:
acquiring an indication of known genetic variants of an individual at predetermined genetic loci;
identifying a product for the individual;
selecting genetic variants from the known genetic variants based on the product;
assigning a value to each selected genetic variant based on an aggregation directive for the product;
calculating a polygenic score for the product based on the value of each selected genetic variant; and
determining whether to recommend the product for the individual based on the polygenic score.

9. The method of claim 8 wherein:
the product is one of multiple candidate products, and for each of the multiple candidate products the method comprises:
selecting genetic variants from the known genetic variants based on the candidate product;
assigning a value to each selected genetic variant based on an aggregation directive for the candidate product;
calculating a polygenic score for the candidate product based on the value of each selected genetic variant; and
determining whether to recommend the candidate product for the individual based on the polygenic score.

10. The method of claim 9 further comprising:
disqualifying candidate products having a polygenic score below a threshold amount; and
generating recommendations for candidate products having a polygenic score above the threshold amount.

11. The method of claim 9 further comprising:
determining an order of prioritization of the candidate products, based on ranks assigned to the candidate products.

12. The method of claim 11 further comprising:
altering a rank assigned to a candidate product in response to determining that the individual has a genetic variant that is categorized as decisive for that candidate product.

13. The method of claim 8 wherein:
the aggregation directive indicates a first value for a first genetic variant at a predetermined genetic locus, and indicates a second value for a second genetic variant at the predetermined genetic locus.

14. The method of claim 8 wherein:
values assigned to the selected genetic variants are based on allele frequency of the selected genetic variants.

15. A non-transitory computer readable medium embodying programmed instructions which, when executed by a processor, are operable for performing a method comprising:
acquiring an indication of known genetic variants of an individual at predetermined genetic loci;
identifying a product for the individual;
selecting genetic variants from the known genetic variants based on the product;
assigning a value to each selected genetic variant based on an aggregation directive for the product;
calculating a polygenic score for the product based on the value of each selected genetic variant; and
determining whether to recommend the product for the individual based on the polygenic score.

16. The medium of claim 15 wherein:
the product is one of multiple candidate products, and for each of the multiple candidate products the method comprises:
selecting genetic variants from the known genetic variants based on the candidate product;
assigning a value to each selected genetic variant based on an aggregation directive for the candidate product;
calculating a polygenic score for the candidate product based on the value of each selected genetic variant; and
determining whether to recommend the candidate product for the individual based on the polygenic score.

17. The medium of claim 16 wherein the method further comprises:
disqualifying candidate products having a polygenic score below a threshold amount; and
generating recommendations for candidate products having a polygenic score above the threshold amount.

18. The method of claim 16 wherein the method further comprises:
determining an order of prioritization of the candidate products, based on ranks assigned to the candidate products.

19. The medium of claim 18 wherein the method further comprises:
altering a rank assigned to a candidate product in response to determining that the individual has a genetic variant that is categorized as decisive for that candidate product.

20. The medium of claim 15 wherein:
the aggregation directive indicates a first value for a first genetic variant at a predetermined genetic locus, and indicates a second value for a second genetic variant at the predetermined genetic locus.
